(19) United States
(12) Patent Application Publication
(10) Pub. No.: US 2014/0360207 A1
(43) Pub. Date: Dec. 11, 2014

(54) THERMAL MANAGEMENT SYSTEM OF BATTERY FOR ELECTRIC VEHICLE

(71) Applicants: Kia Motors Corporation, Seoul (KR); Hyundai Motor Company, Seoul (KR)

(72) Inventors: Yong Hwan Choi, Yongin (KR); Dal Kim, Suwon (KR)

(73) Assignees: Kia Motors Corporation, Seoul (KR); Hyundai Motor Company, Seoul (KR)

(21) Appl. No.: 14/090,580

(22) Filed: Nov. 26, 2013

(30) Foreign Application Priority Data
Jun. 11, 2013 (KR) 10-2013-0066645

(51) Int. Cl. H01M 10/50

(52) U.S. Cl. CPC H01M 10/5002
USPC 62/3.3

(57) ABSTRACT

A thermal management system of a battery for an electric vehicle is provided. The thermal management system controls a temperature of an electric vehicle battery by utilizing a heat pipe connected to a battery module and an insulating pack case and a thermoelectric module connected to the heat pipe and the pack case. The heat pipe performs bidirectional heat exchange and the thermoelectric module heats and cools the heat pipe through current direction change.

### CROSS-REFERENCE TO RELATED APPLICATION

This application claims priority to and the benefit of Korean Patent Application No. 10-2013-0066645 filed in the Korean Intellectual Property Office on Jun. 11, 2013, the entire contents of which are incorporated herein by reference.

### BACKGROUND OF THE INVENTION

(a) Field of the Invention

Embodiments of the present invention relate to a thermal management system of a battery for an electric vehicle and, more particularly, to a thermal management system of a battery for an electric vehicle to control the temperature of the battery.

(b) Description of the Related Art

To solve environmental pollution problems and to develop alternative energy, electric vehicles have begun to be developed in the automotive industry. Generally speaking, an electric vehicle includes a motor (driving motor) for driving the vehicle and a high voltage battery for supplying power to the motor. The battery operates an energy source to provide power to the motor often through an inverter.

This battery is typically a rechargeable battery and is mounted in the electric vehicle in the form of a battery pack. The battery is constructed in such a manner that battery modules composed of a plurality of cells are consecutively connected to generate a requisite amount of power.

The performance of the battery of the electric vehicle is significantly affected by the ambient temperature in which the battery is operating. As such, heat generated by the battery during charging and discharging deteriorates the performance and efficiency of the battery over time. Thus, efforts must be made to control the temperature in which the battery is operating.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a thermal management system of a battery for an electric vehicle having advantages of maintaining a uniform temperature within and around the battery by controlling the temperature of the battery itself to improve the energy efficiency and lifespan of the battery.

An exemplary embodiment of the present invention provides a thermal management system of an electric vehicle battery including a battery module and an insulating pack case encapsulating the battery module. In particular, the thermal management system includes: a heat pipe connected to the battery module and the insulating pack case and performing bidirectional heat exchange; and a thermoelectric module connected to the heat pipe and the insulating pack case. The thermoelectric module heats and cools the heat pipe by changing the direction of the current within the heat pipe.

In some exemplary embodiments of the present invention, the heat pipe may be filled with a working fluid and the plane thereof may have a honeycomb shape. Additionally, the heat pipe may be filled with an amount of working fluid, which corresponds to a third of the working fluid flow area.

Furthermore, thermoelectric module may be embodied as a pair of electrical conduction plates and a bipolar semiconductor interposed between the electrical conduction plates.

The thermal management system may further include a cover for covering the heat pipe, and/or a temperature sensor that is configured to sense the temperature of the battery module and outputting a signal corresponding to a sensed result to a controller.

As such, the controller may also be configured to not apply power to the thermoelectric module when the temperature of the battery module, sensed by the temperature sensor, is greater than a first temperature and less than a second temperature, and the thermoelectric module may transfer heat generated from the heat pipe to the outside of the insulated pack case.

More specifically, during operation, the controller may apply a positive voltage to the thermoelectric module when the temperature of the battery module, sensed by the temperature sensor, is greater than or equal to the second temperature. In this case, the thermoelectric module may absorb the heat of the heat pipe and radiate the heat to outside of the insulated pack case.

The controller may also be configured to apply a negative voltage to the thermoelectric module when the temperature of the battery module, sensed by the temperature sensor, is less than or equal to the first temperature. In this case, the thermoelectric module may absorb heat from outside of the insulating pack case and transfer the heat to the heat pipe.

### BRIEF DESCRIPTION OF THE DRAWINGS

FIG. 1 illustrates a thermal management system of a battery for an electric vehicle according to an exemplary embodiment of the present invention.

FIG. 2 is a perspective view illustrating main components of the thermal management system of a battery for an electric vehicle according to the exemplary embodiment of the present invention.

FIG. 3 illustrates a thermoelectric module applied to the thermal management system of a battery for an electric vehicle according to an exemplary embodiment of the present invention.

FIGS. 4, 5 and 6 are views illustrating the operation of the thermal management system of a battery for an electric vehicle according to the exemplary embodiment of the present invention.

### DETAILED DESCRIPTION OF THE EMBODIMENTS

The present invention will be described more fully hereinafter with reference to the accompanying drawings, in which exemplary embodiments of the invention are shown. The described embodiments may be modified in various different ways, all without departing from the spirit or scope of the present invention.

For clarity of description of the present invention, parts unrelated to description are omitted, and the same reference numbers will be used throughout this specification to refer to the same or like parts.

In the drawings, dimensions and thicknesses of components are exaggerated, omitted or schematically illustrated for clarity and convenience of description. In addition, dimensions of constituent elements do not entirely reflect actual dimensions thereof.

In addition, unless explicitly described to the contrary, the word “comprise” and variations such as “comprises” or “comprising” will be understood to imply the inclusion of stated elements but not the exclusion of any other elements.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles, fuel cell vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Additionally, it is understood that the below processes are executed by at least one controller. The term controller refers to a hardware device that includes a memory and a processor configured to execute one or more steps that should be interpreted as its algorithmic structure. The memory is configured to store algorithmic steps and the processor is specifically configured to execute said algorithmic steps to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

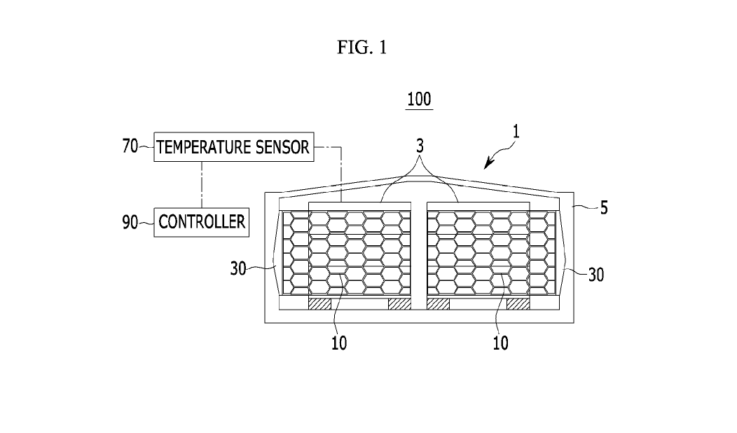

FIG. 1 illustrates a thermal management system 100 of a battery 1 for an electric vehicle according to an exemplary embodiment of the present invention. Referring to FIG. 1, the thermal management system 100 of the battery 1 for an electric vehicle according to an exemplary embodiment of the present invention can be applied to an electric vehicle that powers an electric motor using electric energy contained within the battery 1 and runs according to the power of the motor.

For example, the battery 1 may be a secondary battery capable of charging and discharging high voltage and may be mounted in the electric vehicle in the form of a pack. Accordingly, the battery 1 may include battery modules 3 and an insulating pack case encapsulating the battery modules 3.

The battery pack composed of the battery modules 3 and the pack case 5 may include a heat insulating material (not shown) to prevent heat from being applied/emitted to/from the battery pack and to improve watertight performance of the battery pack. In this case, the heat insulating material can prevent the battery modules 3 from directly coming into contact with the pack case 5 to further improve heat insulation performance.

Arrangement of the battery modules 3 and combination of the battery modules 3 and the pack case 5 are well known in the art so that detailed description thereof is omitted therefrom.

The thermal management system 100 according to an exemplary embodiment of the present invention, however, controls the temperature of the battery 1 and can maintain a uniform temperature of the battery 1 by increasing, maintaining or decreasing the temperature of the battery 1, to improve the energy efficiency and lifespan of the battery 1. More specifically, the thermal management system 100 of the battery for an electric vehicle according to the exemplary embodiment of the present invention includes a heat pipe 10 and a thermoelectric module (TEM) 30.

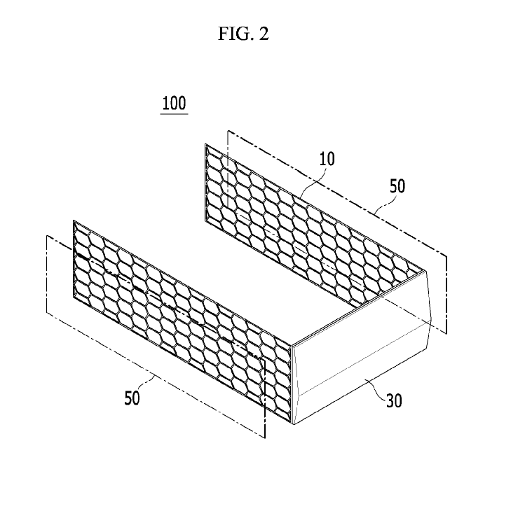

FIG. 2 is a perspective view illustrating main components of the thermal management system 100 of the battery for an electric vehicle according to an exemplary embodiment of the present invention. Referring to FIGS. 1 and 2, the heat pipe 10 is connected to the battery modules 30 and the insulating pack case 5 and enables bidirectional heat exchange between the battery modules 3 and the pack case 5. That is, the heat pipe 10 has a circulating heat transfer structure instead of a uni-directional heat transfer structure to enable bidirectional heat exchange between the battery modules 3 and the insulating pack case 5.

Furthermore, the heat pipe 10 may be connected to the insulating pack case 5 while surrounding the battery modules 3 in a “U” shape and filled with a working fluid such as Freon. As such, the plane of the heat pipe 10 may have a honeycomb-like shape. The quantity of the working fluid filled in the heat pipe 10 may correspond to a third of the working fluid flow area of the heat pipe 10

In an exemplary embodiment of the present invention, the thermoelectric module 30 may use the Peltier effect, may be connected to the heat pipe 10 and the insulating pack case 5 and heats or cools the heat pipe 10 through current directional change. That is, the thermoelectric module 30 absorbs heat of the heat pipe 10 and radiates the heat to the outside of the insulating pack case 5 or absorbs heat from outside of the insulating pack case 5 and transfers the heat to the heat pipe 10 by changing the quantity of current and current direction applied thereto.

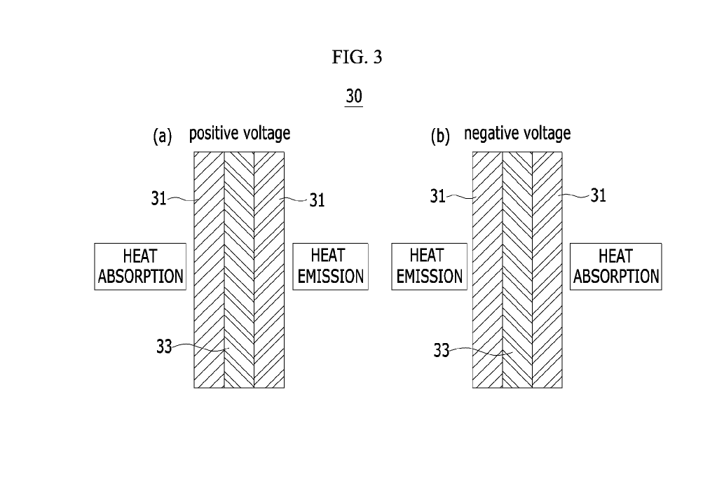

The thermoelectric module 30 may be constructed in such a manner that a bipolar semiconductor 33 is interposed between a pair of electrical conduction plates 31, as shown in FIG. 3. The thermoelectric module 30 absorbs or emits heat on both sides thereof according to the direction of current supplied thereto from a power source. The thermal management system 100 of the battery for an electric vehicle according to the exemplary embodiment of the present invention may further include a cover 50 for covering the heat pipe 10, as shown in FIG. 2, and a temperature sensor 70 that is configured to sense the temperature of the battery modules 3, as shown in FIG. 1.

The cover 50 may be provided to the battery modules 3 and the insulating pack case 5 and may be function as an insulator for preventing thermal loss within the heat pipe 10. In particular, the temperature sensor 70 may sense the temperature of the battery modules 3 and output a signal corresponding to a sensed result to a controller 90. The controller 90 can control operation of the thermoelectric module 30 by applying a positive or negative voltage to the thermoelectric module 30 or not to control the temperature of the battery 1, thus changing the direction of the current as a result.

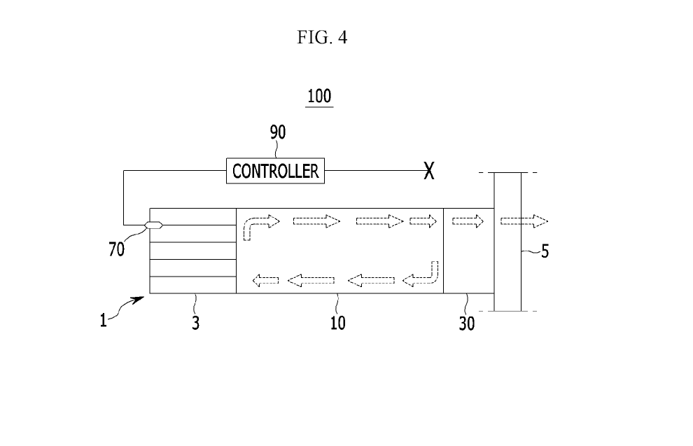

The operation of the thermal management system 100 of the battery for an electric vehicle according to the exemplary embodiment of the present invention will now be described in detail with reference to the attached drawings. FIGS. 4, 5 and 6 are views illustrating the operation of the thermal management system 100 of the battery for an electric vehicle according to the exemplary embodiment of the present invention.

Referring to FIG. 4, according to an exemplary embodiment of the present invention, when the temperature of the battery modules 3, sensed by the temperature sensor 70, is greater than a predetermined first temperature (e.g. 0° C.) and lower than a predetermined second temperature (e.g. 50° C.), the controller 90 is configured to not apply power to the thermoelectric module 30. Then, heat generated from the battery modules 3 can be transferred to the thermoelectric module 30 through the heat pipe 10 and radiated to the outside of the insulating pack case 5 via the thermoelectric module 30. In this case, the thermoelectric module 30 functions as a heat transfer medium that transfers the heat of the battery modules 3, transferred through the heat pipe 10, to the outside of the pack case 5.

The operations of the heat pipe 10 and the thermoelectric module 30 are described in more detail. The part of the heat pipe 10, which corresponds to the battery modules 3, functions as a heat-absorption part that absorbs the heat generated from the battery modules 3 corresponding to a high-temperature part. Accordingly, the part of the heat pipe 10, which corresponds to the battery modules 3, evaporates the working fluid using the heat transferred from the battery modules 3.

The vaporized working fluid moves to the thermoelectric module 30 corresponding to a low-temperature part through the heat pipe 10. Then, the part of the heat pipe 10, which corresponds to the thermoelectric module 30, functions as a heat-radiation part to condense the vaporized working fluid into liquid, emitting latent heat. Accordingly, the heat of the battery modules 3 can be emitted outside of the insulating pack case 5 through the heat pipe 10 and the thermoelectric module 30.

The working fluid liquefied at the part of the heat pipe 10, which corresponds to the thermoelectric module 30, flows toward the bottom of the heat pipe 10 according to gravity and, at the same time, flows towards the battery modules 3 at which a relatively small quantity of working fluid is present as a result of the gravitational movement and convection.

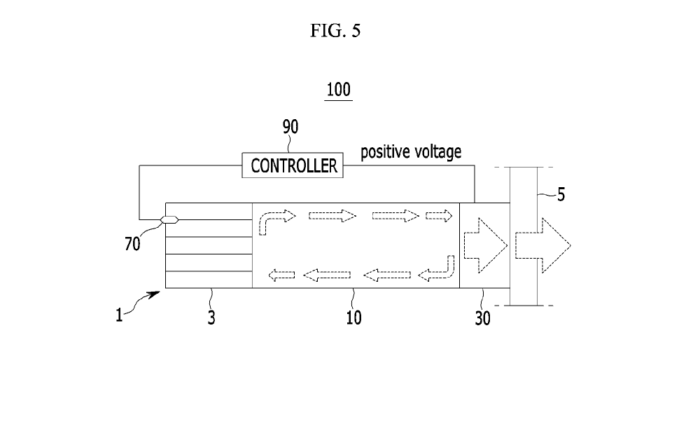

Accordingly, in the embodiment of the present invention, when the temperature of the battery modules 3 is greater than the first temperature (0° C.) and less than the second temperature (50° C.), the heat generated from the battery modules 3 is radiated to outside of the insulating pack case 5 through the heat pipe 10 and the thermoelectric module 30, thereby maintaining a uniform temperature of the battery 1. Referring to FIG. 5, when the temperature of the battery modules 3, sensed by the temperature sensor 70, is greater than or equal to the second temperature (e.g. 50° C.), the controller 90 may be configured to apply a positive voltage to the thermoelectric module 30 thereby controlling the direction of the current.

Then, the heat pipe 10 transfer the heat generated from the battery modules 3 to the thermoelectric module 30 according to the above-described operation. Here, the thermoelectric module 30 can absorb the heat transferred through the heat pipe 10 at one side thereof, radiate the heat through the other side and emit the radiated heat to outside of the insulating pack case 5 since the positive voltage is applied thereto by the controller 90.

Accordingly, when the temperature of the battery modules 3 is greater than or equal to the second temperature, it is possible to improve heat transfer efficiency of the battery modules 3 through the heat pipe 10 and the thermoelectric module 30 by applying the positive voltage to the thermoelectric module 30 and to enhance cooling performance of the battery 1 by cooling the battery modules 3 to less than a predetermined temperature (e.g. 50° C.).

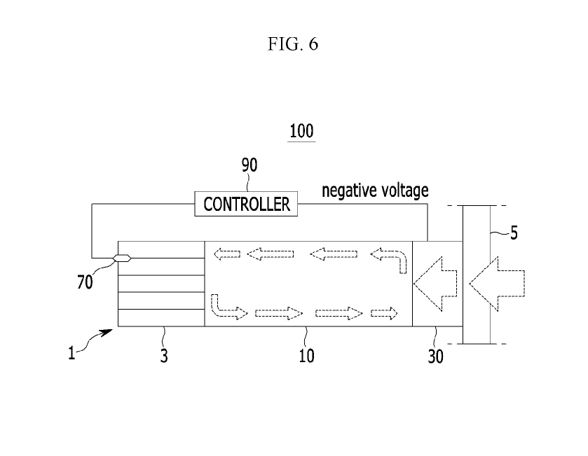

Alternatively, referring to FIG. 6, when the temperature of the battery modules 3, sensed by the temperature sensor 70, is less than or equal to the first temperature (e.g. 0° C.), the controller 90 may apply a negative voltage to the thermoelectric module 30 thereby changing the direction of the current. Then, the thermoelectric module 30 absorbs heat from the outside of the insulating pack case 5 through one side thereof, radiates heat through the other side and transfers the heat to the heat pipe 10. The heat pipe 10 can then transfer the heat from the thermoelectric module 30 to the battery modules 3.

In particular, the part of the heat pipe 10, which corresponds to the thermoelectric module 30, operates as a heat absorption part for absorbing heat generated from the thermoelectric module 30 corresponding to a high-temperature part. Accordingly, the part of the heat pipe 10, which corresponds to the thermoelectric module 30, evaporates the working fluid using the heat transferred from the thermoelectric module 30.

The vaporized working fluid moves toward and through the battery modules 3 corresponding to a low-temperature part through the heat pipe 10. Then, the part of the heat pipe 10, which corresponds to the battery modules 3, operates as a heat radiation part to condense the vaporized working fluid into liquid, thereby emitting latent heat. Accordingly, the heat from the thermoelectric module 3 can be transferred to the battery modules 3 through the heat pipe 10 when necessary.

The working fluid liquefied at the part of the heat pipe 10, which corresponds to the battery modules 3, moves toward the bottom of the heat pipe 10 according to gravity and, at the same time, moves to the thermoelectric module 30 at which a relatively small quantity of working fluid is present.

Accordingly, in the embodiment of the present invention, the thermoelectric module 30 can absorb heat from outside of the insulating pack case 5 and transfer the absorbed heat to the heat pipe 10 when the temperature of the battery modules 3 is lower than a predetermined temperature, thereby increasing the temperature of the battery modules 3.

According to the thermal management system of the battery for an electric vehicle according to the above-described exemplary embodiment of the present invention, it is possible to maintain a uniform temperature of the battery 1 by controlling the temperature of the battery 1 through the honeycomb type heat pipe 10 and the thermoelectric module 30. Accordingly, the energy efficiency and lifespan of the battery 1 can be improved to reduce costs and improve the driving performance of the electric vehicle.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A thermal management system of an electric vehicle battery including a battery module and an insulating pack case encapsulating the battery module, comprising:
a heat pipe connected to the battery module and the insulating pack case, wherein the heat pipe performs bidirectional heat exchange; and
a thermoelectric module connected to the heat pipe and the insulating pack case, wherein the thermoelectric module heats and cools the heat pipe by changing the direction of the current.

2. The thermal management system of claim 1, wherein the heat pipe is filled with a working fluid and a plane thereof has a honeycomb shape.

3. The thermal management system of claim 1, wherein the heat pipe is filled with an amount of working fluid, which corresponds to a third of the working fluid flow area.

4. The thermal management system of claim 1, wherein the thermoelectric module includes a pair of electrical conduction plates and a bipolar semiconductor interposed between the electrical conduction plates.

5. The thermal management system of claim 1, further comprising a cover that covers the heat pipe.

6. The thermal management system of claim 1, further comprising a sensor that senses a temperature of the battery module and outputs a signal corresponding to a sensed result to a controller.

7. The thermal management system of claim 6, wherein the controller is configured to not apply a voltage to the thermoelectric module when the temperature of the battery module, sensed by the temperature sensor, is greater than a first temperature and less than a second temperature,
wherein the thermoelectric module transfers heat generated from the heat pipe to outside of the insulating pack case.

8. The thermal management system of claim 6, wherein the controller is configured to apply a positive voltage to the thermoelectric module when the temperature of the battery module, sensed by the temperature sensor, is greater than or equal to the second temperature,
wherein the thermoelectric module absorbs the heat of the heat pipe and radiates the heat to outside of the insulating pack case.

9. The thermal management system of claim 6, wherein the controller is configured to apply a negative voltage to the thermoelectric module when the temperature of the battery module, sensed by the temperature sensor, is less than or equal to the first temperature,
wherein the thermoelectric module absorbs heat from outside of the pack case and transfers the heat to the heat pipe.

10. A method for controlling the temperature of a battery, the method comprising:
determining, by a controller, whether or not to apply a voltage to a thermoelectric module based on a sensed temperature of a battery module;
in response to the temperature of the battery module being greater than a first temperature and less than a second temperature, determining, by the controller, not to apply a voltage to the thermoelectric module, wherein the thermoelectric module transfers heat generated from the heat pipe to outside of the insulating pack case;
in response to the temperature of the battery module being greater than or equal to the second temperature, applying, by the controller, a positive voltage to the thermoelectric module, wherein the thermoelectric module absorbs the heat of the heat pipe and radiates the heat to outside of the insulating pack case; and
in response to the temperature of the battery module being less than or equal to the first temperature, applying, by the controller, a negative voltage to the thermoelectric module, wherein the thermoelectric module absorbs heat from outside of the pack case and transfers the heat to the heat pipe.

11. A non-transitory computer readable medium containing program instructions executed by a controller, the computer readable medium comprising:
program instructions that determine whether or not to apply a voltage to a thermoelectric module based on a sensed temperature of a battery module;
program instructions that determine not to apply a voltage to the thermoelectric module in response to the temperature of the battery module being greater than a first temperature and less than a second temperature, wherein the thermoelectric module transfers heat generated from the heat pipe to outside of the insulating pack case;
program instructions that apply a positive voltage to the thermoelectric module in response to the temperature of the battery module being greater than or equal to the second temperature, wherein the thermoelectric module absorbs the heat of the heat pipe and radiates the heat to outside of the insulating pack case; and
program instructions that apply a negative voltage to the thermoelectric module in response to the temperature of the battery module being less than or equal to the first temperature, wherein the thermoelectric module absorbs heat from outside of the pack case and transfers the heat to the heat pipe.
